(19) United States
(12) Patent Application Publication
(10) Pub. No.: US 2019/0022918 A1
(43) Pub. Date: Jan. 24, 2019

(54) METHOD FOR THE PREPARATION OF AN ARTICLE

(71) Applicant: Louis Rinze Henricus Adrianus WILLEMSEN, Las Pinas City (PH)

(72) Inventor: Egidius Petrus Gerardus CLARIJS, Kruiningen (NL)

(21) Appl. No.: 16/083,037

(22) PCT Filed: Mar. 7, 2017
(86) PCT No.: PCT/NL2017/050133

§ 371 Date: Sep. 7, 2018

(30) Foreign Application Priority Data
Mar. 8, 2016 (NL) 2016394

(51) Int. Cl. B29C 51/42

(52) U.S. Cl. CPC B29C 51/428; B29K 2995/006; B29K 2003/00; B29K 2267/046; B29K 2403/00; B29K 2803/00; B29K 2203/00

(57) ABSTRACT

Described is a method for the preparation of an article, in particular a biodegradable article, from a thermoplastic composition comprising starch by thermoforming, comprising the steps of providing a sheet of the thermoplastic composition in rubber phase at a temperature of at least 100° C., stretching the sheet into or onto a mould, cooling the sheet to form the article, remove the article from the mould, wherein the mould in step b has a temperature of 5° C. or less, the sheet in step c is cooled to a temperature of 40° C. or less, steps b and c being performed in 10 s or less. Further, a thermoformed article, obtainable by the said method and the use of such an article is described.

The invention relates to a method for the preparation of an article from a thermoplastic composition comprising starch by thermoforming, to a thermoformed article obtainable by the said method, and to the use of said article. Said article is preferably biodegradable.

Articles, in particular biodegradable articles, made from a composition comprising starch are known in the art, but these are prepared by moulding techniques. Herein, the term ‘article’ is deemed identical to the word ‘product’.

Starch is well known in the art as biodegradable thermoplastic material. However, native starch has a granular structure, and should be destructurized in order to obtain thermoplastic behaviour. Such destructuring is usually obtained by mechanical stress at elevated temperature, and can e.g. be achieved by subjecting native starch to an extrusion process, such as described in e.g. U.S. Pat. No. 4,673,438, wherein the preparation of starch capsules was described wherein starch was destructured and combined with a lubricant and a plasticizer. The use of a plasticizer facilitates destructuring the starch. A suitable starch plasticizer is capable of embedding between the polysaccharide chains of the starch, as a result of which the chains are spaced apart, resulting in a decrease in viscosity of the polymeric melt and decrease in glass transition temperature. It is to be noted that a compound can be a plasticizer for a first polymer may not be a plasticizer for a second polymer, as e.g. the spacing between the polymer chains in the second polymer may be smaller and not allow embedding of the compound between the polymer chains.

WO99/29733 describes a method for the preparation starch based biodegradable mouldings by extrusion or injection moulding, wherein a composition comprising potato skins are subjected to a thermomechanical treatment and then shaped. Up to 25 w/w % plasticizer, in particular glycerol, was incorporated in the composition in order to confer elasticity to the composition, necessary for moulding.

WO2008/014573 discloses injection mouldable biodegradable polymer compositions comprising starch, a polyvinyl alcohol, polyvinyl acetate or ethylene-polyvinyl alcohol copolymers and a polyol as a starch plasticizer The polyvinyl (co)polymer is incorporated to improve water resistance, elasticity and to lower brittleness of the article, produced by injection-moulding of the composition.

WO2011/053131 describes an improved composition in order to produce starch plastic articles of less rigidity and brittleness. To this end, the composition comprises starch, vinyl ester polymer, a starch plasticizer as well as a plasticizer for the vinyl ester polymer. The starch plasticizer is a polyol, in particular glycerol, whereas the plasticizer for the vinyl ester polymer is described to be diacetin. According to WO2011/053131, it is important to add the plasticizer for the vinyl ester polymer after the starch is destructurized, and that the said plasticizer is not a plasticizer for starch, i.e. does not have a significant effect on the viscosity of the starch. By extrusion compounding and subsequent underwater pelletizing pellets can be obtained. Allegedly, the pellets are described to be suitable for injection moulding, sheet extrusion and subsequent thermoforming, blow moulding and foaming. However, none of these thermoplastic processing techniques were in fact disclosed in WO2011/053131. The only true product described is a film, prepared by film blowing a composition that comprises both starch and polylactic acid in a weight ratio of 1:1.23.

JP2006007657 describes a method to confer plastic properties to a polymeric sheet, enabling the polymeric sheet to be subjected to moulding at ambient temperature without the need to heat the polymeric sheet. To this end, the sheet is subjected to pressure and is contacted with carbon dioxide when depressurized, allowing the sheet to be subjected to deep-drawing moulding at ambient temperature. The depressurizing takes an hour or more in order to avoid foaming of the sheet material. Suitable polymers are polymers that are brittle, such as polystyrene and polymethylmethacrylate (PMMA). Some biodegradable resins are mentioned in JP2006007657, such as polyvinyl alcohol and polylactate, but is silent about starch. Moreover, the only examples given in JP2006007657 relate to PMMA.

JP2005194415 describes the preparation of a polylactic sheet having improved oxygen barrier properties. To this end, the polylactic acid is blended with a nucleus agent such as talc, and after a sheet is made by extrusion and cast rolling, the sheet is heated to 120-150° C. for 3-20 s. When an article is to be made by pressure-forming, it is suggested to heat the mould at this temperature. As JP2006007657, JP2005194415 is silent with regard to starch and concomitant moulding problems as described above.

Until the present invention was made however, it was not possible to produce a thermoformed product using a thermoplastic composition comprising starch. The obtained products were still undesirably brittle and rigid, or could not be removed from the mould. In thermoforming, a sheet of the composition is brought in the rubber phase, e.g. by heating a pre-prepared sheet of the thermoplastic composition to above the glass transition temperature of the composition, and capable of being irreversibly deformed. Such a sheet can also be prepared in an upstream inline sheet extruder. Said rubber sheet is then stretched into or onto a mould, and the sheet is allowed to cool while the article is formed. After cooling down to a temperature where the sheet material retains its form, which may be below the glass transition temperature, but also above, while the material is still rubbery, the cooled formed article is removed from the mould. By said process, a plurality of articles can be formed in a mould, and be separated from one another after the articles are removed from the mould. After removal of the articles from the mould, another sheet or sheet portion can be stretched into or onto the mould, allowing for a continuous process. Usually, the mould is cooled to ambient temperature, about 20° C., to cool the sheet before removal of the article.

It has now surprisingly been found that when a composition comprising starch is used for thermoforming to produce biodegradable articles, the step of cooling the sheet while in contact with the mould should be a flash-cooling step, i.e. resulting in the sheet to cool down to a lower temperature in a short time period. To this end, disclosed is a method for the preparation of an article from a thermoplastic composition comprising starch by thermoforming, comprising the steps of:
a) providing a sheet of the thermoplastic composition in rubber phase at a temperature of at least 100° C.,
b) stretching the sheet of step a) into or onto a mould,
c) cooling the sheet while stretched in or on the mould to form the article,
d) remove the article formed in step c) from the mould,
   wherein the mould in step b) has a temperature of 15° C. or less, the sheet in step c) is cooled to a temperature of 40° C. or less, steps b) and c) being performed in 10 s or less.

Starch contains amylose or amylo-pectin, or a mixture thereof. Starch usually has a molecular weight of 10 to 2×10⁴ kD. The term ‘starch’ as used herein means that the composition comprises starch of any source, e.g. from vegetables such as potato, wheat, corn, rice, peas, tapioca starch, but can also be modified starch, such as crosslinked starch using a crosslinking agent such as epichlorohydrin, dicarboxylic acid anhydride, formaldehyde, phosphorus oxychlorine, metaphosphate, acrolein, organic divinylsulfons etcetera, or using microwaves; starch co-polymers such as styrene butadiene grafted with starch; starch derivatives such as oxidised starch, starch mono- or diphosphate, starch acetate, starch hydroxyethylether, carboxymethyl starch, starch ether, hydroxypropylated starch, such as 2-hydroxypropyl starch, alphatized starch, starch xanthide, starch chloroacetic acid, starch ester, formaldehyde starch, sodium carboxymethyl starch, starch modified with octenyl succinic anhydride, etcetera. The starch can also be pretreated by enzymes or chemicals such as acids to yield dextrines, or be pregelatinized or treated with ultrasonic waves or gamma radiation. A combination of one or more of the above can also be used in the thermoplastic composition used herein.

According to the present disclosure, the mould has a low temperature of 15° C. or less, resulting in the sheet to be cooled to a temperature of 40° C. or less within 10 s or less. The temperature of the sheet is the outer temperature, i.e. at the surface thereof. The inner temperature may be somewhat higher, but in view of the relative limited thickness of the sheet of usually below 5 mm and preferably in the range of 0.2-5 mm, more preferably 0.5-3 mm the temperature difference between the surface and the core of the sheet will not be more than 1 to 3° C. As indicated above, it is important that cooling takes place until the formed sheet has form retaining properties. The skilled person will immediately understand how to set the parameters of the thermoforming equipment to arrive at the above mould temperature, cooling time and (outer) temperature of the sheet after cooling. For example, the mould can be cooled by a cooling medium, such as water. To this end, the mould may have intern channel allowing cool medium to flow through and to absorb heat from the mould and keep the mould at or below an envisaged temperature. The temperature and the flow of the cooling medium can be chosen accordingly. Preferably, steps b, c and d are performed in 10 s or less, allowing for a new sheet portion to be stretched into or onto the mould.

It was surprisingly found that the thermoformed articles were bendable, not brittle, without cracking. Very surprisingly, it was observed that the material was damp permeable, but water tight. Nevertheless, a very surprising water absorbing property was observed, allowing the new material to be used as desiccant. Articles, produced from similar thermoplastic compositions but by different techniques, e.g. by injection moulding did not have such a porous structure resulting in damp permeability and water absorbing property. Further, it was surprisingly observed that water containing items, in particular coloured water containing items, such as fresh fruits or vegetables such as strawberries or tomatoes, when in contact with the article, do not stain the article. Therefore, in a very advantageous embodiment, the described method provides articles such as containers, that are very suitable for transport, storage or presentation of vegetables or fruits. The damp permeability also provided for extended freshness of fruits and vegetables when kept in a closed container as prepared according to the disclosed method, as compared to when kept in commonly used plastic containers (polyethylene terephthalate) that are not damp permeable. For strawberries and tomatoes, it was found that decay was attenuated by several days when kept in a closed container as prepared according to the disclosed method. The same was true when meat was packed in the above-described containers, sealed with foil. It was observed that meat juice was absorbed by the container material, so that the presence of an absorber pad in the container became superfluous. Surprisingly, said absorbing did usually not coincide with staining of the container material, in particular in case of poultry and fish.

In a preferred embodiment, the mould in step b) has a temperature of 10° C. or less, preferably of 8° C. or less, in order to provide for an improved flash cooling effect, resulting in optimal thermoforming and articles with the desired properties as described above. To this end, the cooling medium, in particular water, preferably has a temperature of 75° C. or less, more preferably 6° C. or less and even more preferably 5° C. or less. However, lower temperatures are possible in case articles of the higher thickness are envisaged, in order to cool the sheet material in the mould sufficiently in the time given to confer form retaining properties to the material in order to be removed from the mould.

Accordingly, it is preferred to cool the sheet in step c) to a temperature of 30° C. or less, more preferably 20° C. or less, even more preferably to 15° C. or less.

In order to expedite the process, it is preferred for steps b) and c) to be performed simultaneously. As indicated above, this can be done by cooling the mould. However, it is also possible to first stretch the sheet into or onto the mould and perform a subsequent cooling step, e.g. by forced air, or to combine simultaneous cooling and moulding with an additional cooling step.

In order to improve the flash cooling even more and to arrive at improved articles, steps b) and c) and preferably also step d) are performed in 5 s or less, more preferably in 4 s or less, even more preferably in 3 s or less, most preferably in 2.5 s or 2 s or less. Such a short time for stretching and cooling, and optionally removal of the articles from the mould not only results in improved products, but also enables efficient production in a continuous process, allowing 12 to 30 rounds of steps b), c) and d) per minute. Shorter time periods are less preferred as these are technically less feasible. In the described method steps a)-d) are therefore preferably repeated in a continuous process.

In a preferred embodiment, the thermoplastic sheet in step a) has a temperature of at least 110° C., and/or of 135° C. or less. Although the temperature range wherein a thermoplastic composition is in the desired rubber phase depends on amount and nature of the polymers in the composition, the said temperature range is very suitable for compositions that comprise starch, in particular when, on weight basis, the majority of the thermoplastic polymers in the composition is starch, or at least a significant portion of 30 w/w % or more.

In another attractive embodiment, the thermoplastic composition comprises at least 50 w/w %, preferably at least 55 w/w %, more preferably at least 60 w/w %, even more preferably at least 65 w/w % starch, based on the total dry weight of the composition. The thermoplastic composition preferably comprises 85 w/w % or less, preferably 80 w/w % or less, more preferably 75 w/w % or less, most preferably 70 w/w % or less starch, based on the total dry weight of the composition. Said starch is preferably of vegetable origin, preferably derived from potato, wheat, corn, rice, peas, tapioca starch, most preferably from potato. The most preferred source for starch are potato skins, as described in WO99/29733. Preferably, in order to improve the destructurizing of the starch and to confer improved thermoplastic behaviour and lower viscosity, the thermoplastic composition comprises a starch plasticizer, in particular 3-30 w/w %, based on the dry weight of the starch. The starch plasticizer is preferably chosen from the group, consisting of polyols, citric acid ester, urea or combinations of two or more thereof, the starch plasticizer preferably being a polyol, chosen from the group, consisting of glycol, alkylene glycol, polyalkylene glycol, glycerol, glycerol monoester, or a combination of two or more thereof, preferably glycerol. However, also maltitol, sorbitol, etythritol and xylitol or combinations of two or more thereof, or in combination with glycerol are advantageous.

In a very attractive embodiment, the thermoplastic composition of step a comprises an elastomer. In particular elastomers that are used in chewing gum base are preferred, the thermoplastic composition preferably comprising 20-50 w/w % elastomer, based on the total dry weight of the composition. Attractive elastomers are chosen from the group, consisting of vinyl ester polymers, styrene-butadiene copolymers and isoprene-butadiene copolymers or a combination of two or more thereof. The elastomer should be chosen such, that the composition in step a is in the rubber phase and not form retaining, in order to be stretched over or into the mould in step b. Preferably, the elastomer is a vinyl ester, chosen from the group, consisting of homo-, co- or terpolymers, the vinyl ester preferably being a vinyl acetate, more preferably a copolymer of ethylene and vinyl acetate. The molecular weight of the vinyl ester (co)polymer is preferably in the range of 90,000 to 112,000, where higher molecular weight appears to improve impact resistance and water sensitivity. Accordingly, higher molecular weight vinyl ester (co)polymer may also be preferred. Compositions comprising such elastomers, e.g. described in WO2008/014573 and WO2011/053131 can optimally be used in the method described herein. For that reason, the vinyl ester as disclosed in these two documents are explicitly incorporated herein, in particular the Vinnex products 2504, 2505 and 2510 of Wacker Chemie, Germany, as described in WO2011/053131.

In a very attractive embodiment, the thermoplastic composition comprises an elastomer plasticizer. Said elastomer plasticizer preferably is not a plasticizer for starch. It has been found that elastomeric compositions that comprise both starch, an elastomer and an elastomer plasticizer, and preferably also a starch plasticizer, are optimally suitable for the preparation of articles by thermoforming. The thermoplastic composition preferably comprises 0.5-25 w/w %, more preferably 3-13 w/w % elastomer plasticizer, based on the dry weight of the elastomer.

The elastomer plasticizer is preferably chosen from the group, consisting of glycerine acetates, alkyl citrates, alkyl citrate esters, paraffin, micro waxes, vegetable oil or a combination of two or more thereof. Such plasticizers are commonly used in gum base for chewing gum. In a very attractive embodiment, the plasticizer comprises a glycerine acetate, preferably diacetyl glycerol, which has been shown to be a very suitable plasticizer for vinyl acetate polymers or copolymers, in particular ethylene vinyl acetate polymers.

In an attractive embodiment, the prepared article is biodegradable. The term ‘biodegradable’ is known in the art, and for the sake of the present disclosure means that the article, prepared from the thermoplastic composition can be biologically broken down, i.e. be decomposed by the action of living organisms, in particular micro-organisms such as bacteria, algae or fungi. In order for the article to be biodegradable, the thermoplastic composition including all its constituents is preferably biodegradable as well.

In another attractive embodiment, the thermoplastic composition as described above is blended with one or more additional polymers to form a thermoplastic blend, and wherein in step a a sheet of the thermoplastic blend in rubber phase is provided. In this embodiment, additional polymers, in particular biodegradable polymers can be blended with the elastomeric composition to confer desired properties to the articles. To this end, the thermoplastic blend comprises, based on the total weight of the blend, preferably 30-90 w/w % of the thermoplastic composition and 10-70 w/w % additional polymers preferably 50-80 w/w % of the thermoplastic composition and 20-50 w/w % additional polymers.

The one or more additional polymers in the thermoplastic blend comprise one or more biodegradable polymers, in particular chosen from the group, consisting of polylactic acid, polycaprolacton, polybutylene succinate, polyhydroxybutyrate, poly(butylene-adipate-co-terephtalate) or a combination of two or more thereof. The blend preferably comprises polylactic acid.

Further, the composition or the blend may further comprise fillers as known in the art, such as e.g. described in WO2008/014573, herein incorporated by reference. The composition may comprise 0.5 w/w %-30 w/w % or more, preferably 5-20 w/w % and more preferably 8-15 w/w % fillers. Fillers are inert and do not form a part of the polymeric matrix.

In particular, cellulosic fillers are very suitable to be incorporated in the thermoplastic composition or the thermoplastic blend as described above. Examples of cellulosic fillers include sawdust, wheat pulp, wood flakes, ground wood, wood flour, straw, rice hulls, coconut shells peanut shells, in particular vegetable fibres, such as palm fibres, bamboo fibre, kenaf, in particular Miscanthus fibers, such as fibres of Miscanthus sinensis. The fillers preferably are particulate of fibres having a diameter of 700 μm or less, more preferably of 600 μm or less, even more preferably of 500 μm or less. In case of fibres, the fibre length is preferably 2 cm or less, more preferably However, other suitable or conventional materials, known to the skilled person, such as inorganic fillers can be used, e.g. talc, calcium carbonate, kaolin clay, magnesium oxide, titanium oxide, silica, mica, barium sulphate, acrylics and other suitable materials.

In an attractive embodiment, the method further comprises a step e) of preparing a particulate of the article obtained in step d). Such a particulate can very attractively be used as desiccant as will be explained further below. The particle size of the particulate is not critical and depends on the envisaged use. An article, formed in step d), such as a sheet like material, can be subjected to a shredding step, optionally followed by sieving to obtain a particulate of uniform size. Particle diameters of 0.2 mm to 5 mm are attractive as desiccant.

Also presented is a thermoformed article, in particular biodegradable, obtainable by the above-described method, which were not possible to be made until the present disclosure. As described above, such articles further have surprising characteristics in view of flexibility and damp permeability, and water absorbing properties and tightness. This makes such articles perfectly suitable to be shaped as containers for many applications, such as for food, in particular perishable vegetables, fruits and meat resulting in increased storage times for such vegetables, fruits and meat. Such containers preferably are shaped to have a bottom portion and a circumferential wall, which container can be sealed by a foil or closed by a lid of e.g. transparent material. In view of the above properties, the article preferably comprises a non-laminated single layer of the thermoplastic composition or blend.

Regarding the above, a thermoformed article as disclosed herein can be used as fruit, vegetable or meat container.

Also presented is a particulate, obtainable by the described method. It has surprisingly found that the material absorbs water even better than the commonly used silica beads, and are therefore perfectly suitable as desiccant in order to keep the humidity in a closed space at a low level. This is particularly suitable for storage of powder materials, such a vitamin preparations, such as the vitamin cocktail marketed under the trade name Centrum, by Pfizer, Inc. The material of the invention can also be used in packages of electronic equipment, that is vulnerable to humidity. In an attractive embodiment, the package itself, or a portion thereof can be made of the material described herein, providing for the envisaged desiccant property.

Also provided is a container comprising goods susceptible to deterioration by humidity, said container further comprising the article or the particulate as described herein.

The invention will now be further illustrated by the following examples. Pellets of compositions of examples 1-4 of WO2011/053131, prepared and formulated as described therein using the ingredients as described therein, as well as Solanyl C2201, (Rodenburg, the Netherlands) were heated to 160° C. and formed into sheet rolls using a Battenfeld-Bext 60 30DV cast extruder (Germany) having a thickness varying from 300 to 1200 μm and a width of 585 mm.

The sheets were fed in a thermoforming apparatus (Illig R45, Germany, or Kiefel KMV 50D, Germany) where the sheets were heated to 110-115° C., and stretched in water-cooled moulds to form containers having a length varying from 10 to 20 cm, a width from 6 to 15 cm and a height of 5 to 10 cm. The cool water temperature was 5° C., the mould had a temperature varying between 5 and 8° C. when sheets of a thickness of 300-500 μm were moulded, of about 8-10° C. for sheets of 800 μm, and 8-15° C. for sheets of 1200 μm. The temperature of the containers when removed from the moulds was about 20-25° C. The thermoforming cycle of stretching, cooling and removing varied from 5 to 30 cycles per minute.

With all compositions and blends, thermoformed container articles were produced, suitable for holding fresh fruit and vegetables. When a mould temperature of 20° C. was applied instead of 5° C., it was not possible to form and remove articles from the mould.

Containers as obtained were loaded with strawberries or tomatoes and sealed with a transparent film of polylactic acid and kept at 18° C. to simulate conditions in a supermarket. In parallel, strawberries and tomatoes of the same batches were packed similarly in containers of similar dimension, but made of polyethylene terephthalate and kept at identical conditions. It could clearly be observed that both the strawberries and the tomatoes had a prolonged storage life when packed in the containers as prepared according to the examples, in particular when the Rodenburg product was used to prepare the containers. The storage life was extended by up to 3 days for strawberries, and up to 5 days for tomatoes. The same was done for packaging chicken meat in similar sealed containers, resulting in a prolonged shelf life of about 4 days at 4° C. It was observed that in the container, no meat juice was observed, whereas this was the case for chicken of the same batch that were packaged in similar polyethylene terephthalate containers comprising an absorbent pad. No stains were visible in the container made from starch based material. Similar results were obtained for containers, made of the above compositions and blends of the invention that comprised 10 w/w % Miscanthus fibre as filler material. Husk of the betel palm Areca catechu was shown to be suitable as well.

In a water absorption test, the silica beads as present in plastic jars of vitamin preparations of Pfizer, marketed under the trade name Centrum (180 pills) were used as control. All compositions and blends prepared as described above showed a significantly higher water damp absorbance per weight material as compared to the silica beads of the control.

1-60. (canceled)

61. A method for the preparation of an article from a thermoplastic composition comprising starch by thermoforming, comprising the steps of:
a) providing a sheet of the thermoplastic composition in rubber phase at a temperature of at least 100° C.,
b) stretching the sheet of step a) into or onto a mould,
c) cooling the sheet while stretched in or on the mould to form the article,
d) remove the article formed in step c) from the mould, wherein the mould in step b) has a temperature of 15° C. or less, the sheet in step c) is cooled to a temperature of 40° C. or less, steps b) and c) being performed in 10 s or less.

62. The method of claim 61, wherein the mould in step b) has a temperature of 8° C. or less.

63. The method of claim 61, wherein the sheet in step c) is cooled to a temperature of 15° C. or less.

64. The method of claim 61, wherein the thermoplastic composition comprises at least 50 w/w % starch, based on the total dry weight of the composition.

65. The method of claim 61, wherein the starch in the thermoplastic composition is derived from potato, potato skin, wheat, corn, rice, peas, tapioca starch.

66. The method of claim 65, wherein the thermoplastic composition comprises 3-30 w/w % of a starch plasticizer, based on the dry weight of the starch.

67. The method of claim 65, wherein the starch plasticizer is chosen from the group, consisting of polyols, citric acid ester, urea or combinations of two or more thereof.

68. The method of claim 61, wherein the thermoplastic composition comprises 20-50 w/w % of an elastomer, based on the total dry weight of the composition.

69. The method of claim 68, wherein the elastomer is chosen from the group, consisting of vinyl ester polymers, styrene-butadiene copolymers and isoprene-butadiene copolymers or a combination of two or more thereof.

70. The method of claim 61, wherein the thermoplastic composition comprises 0.5-25 w/w % of an elastomer plasticizer, based on the dry weight of the elastomer.

71. The method of claim 70, wherein the elastomer plasticizer is chosen from the group, consisting of glycerine acetates, alkyl citrates, alkyl citrate esters, paraffin, micro waxes, vegetable oil or a combination of two or more thereof.

72. The method of claim 61, wherein the thermoplastic composition is blended with one or more additional polymers to form a thermoplastic blend comprising, based on the total weight of the blend, 30-90 w/w % of the thermoplastic composition and 10-70 w/w % additional polymers and wherein in step a) a sheet of the thermoplastic blend in rubber phase is provided.

73. The method of claim 72, wherein the one or more additional polymers in the thermoplastic blend comprise one or more biodegradable polymers.

74. The method of claim 73, wherein the biodegradable polymers are chosen from the group, consisting of polylactic acid, polycaprolacton, polybutylene succinate, polyhydroxybutyrate, poly(butylene-adipate-co-terephtalate) or a combination of two or more thereof.

75. Method of claim 61, wherein the thermoplastic composition or thermoplastic blend comprises 0.5-30 w/w % of a filler.

76. The method of claim 75, wherein the cellulosic filler comprises vegetable fibres.

77. The method of claim 76, wherein the vegetable fibres comprise Miscanthus fibres.

78. The method of claim 61, further comprising a step e) of preparing a particulate of the article obtained in step d).

79. The method of claim 61, wherein the sheet in step a) has a thickness of 0.2-5 mm.

80. A thermoformed article, obtained by the method of claim 61, comprising at least 50 w/w % starch.
